(19) United States
(12) Patent Application Publication
(10) Pub. No.: US 2002/0152075 A1
(43) Pub. Date: Oct. 17, 2002

(54) Composite input method

(76) Inventors: Shao-Tsu Kung, Taipei (TW); Kang-Yeh Yu, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/836,209

(22) Filed: Apr. 16, 2001

(51) Int. Cl. G10L 21/00

(52) U.S. Cl. 704/270

(57) ABSTRACT

An input method combining verbal and handwritten inputs includes generating a first list according to a speech recognition algorithm, generating a second list according to a character recognition algorithm, and generating a third list that is the intersection of characters from the first list and the second list.

### BACKGROUND OF THE INVENTION

1. Field of the Invention

The present invention relates to an input method, and more particularly, to an input method that simultaneously integrates verbal and handwriting inputs.

2. Description of the Prior Art

With ubiquity of computer systems, such as desktop computers, personal digital assistants, and pocket PCs, input methods for all of these various kinds of computer systems are required for interfaces between users of the computer systems and the computer systems themselves. Such input systems are necessary for a user to input desired information. Two user-friendly input methods for current computer systems include verbal inputs and handwriting inputs, and both of them have their corresponding disadvantages. The verbal input method, such as speech-recognition algorithms, encounters severe difficulties when applied to tonal languages, such as Mandarin. Even more frequently than in English, with tonal languages, existing speech identification systems are unable to accurately determine the word a user is saying. A plurality of choices may be offered as the result, then, of a single spoken word. Handwriting recognition algorithms suffer from a similar flaw, especially with complex ideograms, such as the Chinese character set, and may also offer up several characters in response to a single input character. Alternatively, the handwritten input of characters, such as Chinese characters, is performed block-wise, with each character divided into several parts according to stroke or pronunciation. Learning such an input system is not an easy task for many users, and for them the input speed will of course be slowed.

### SUMMARY OF THE INVENTION

It is therefore an objective of the present invention to provide an input method that integrates a verbal input method and a character recognition method, allowing a user to input by both speaking and writing at the same time. An intersection of characters determined by both the verbal input method and the character recognition input method can be chosen. By combining these two kinds of input methods and integrating both of them at the same time, the present invention offers a beneficial input method that is able to overcome problems encountered by the verbal input method or the handwriting input method applied independently.

In accordance with the claimed invention, an input method combining verbal and character recognition inputs includes generating a first list according to a speech recognition algorithm, generating a second list according to a character recognition algorithm, and generating a third list that is the intersection of characters from the first list and the second list. The third list of characters is then presented to a user.

It is an advantage of the present invention that by integrating the verbal input method and the handwriting recognition method, and furthermore utilizing these methods to generate a word list that consists of intersections of output word lists according to the verbal input method and the handwriting recognition input method, a more accurate and smaller list is provided to the user. The input method according to the present invention is thus able to resolve problems associated with slow writing when using the handwriting input method only, and unclear character identification when using the verbal input method only. Time spent on inputting characters is correspondingly reduced, while accuracy is enhanced.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a perspective view of a computer system with an input method according to the present invention.

FIG. 2 is a block diagram of the computer system shown in FIG. 1.

FIG. 3 is an alternative block diagram of the computer system of FIG. 1.

FIG. 4 is a block diagram of a first list, a second list, and a third list with character intersections of the first list and the second list.

### DETAILED DESCRIPTION OF THE PREFERRED EMBODIMENT

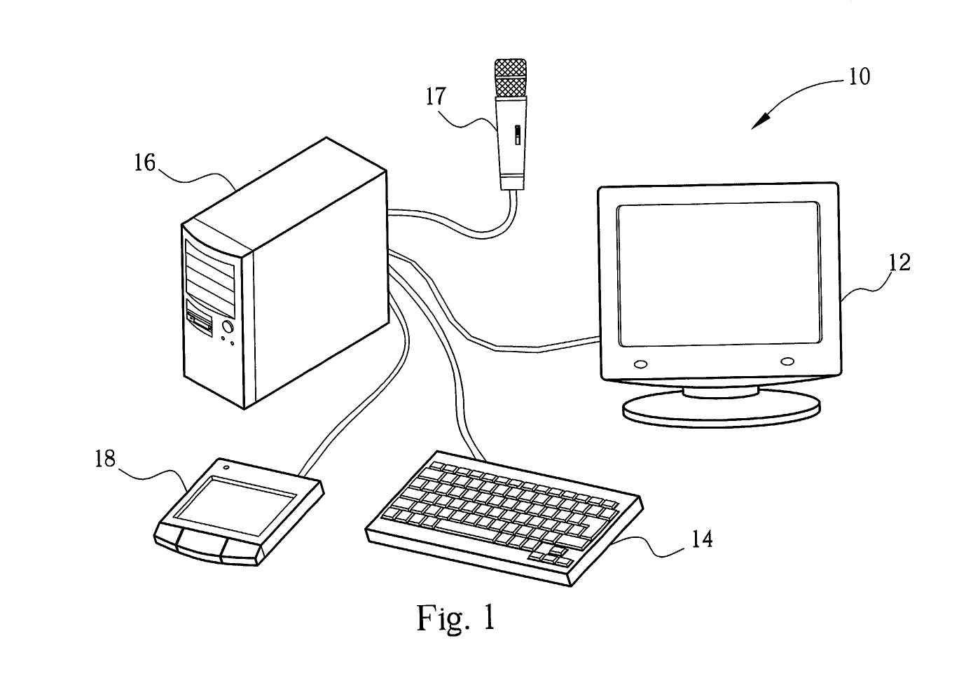

Please refer to FIG. 1. FIG. 1 is a schematic diagram of a computer system 10 that utilizes an input method according to the present invention. The computer system 10 includes a display 12, a keyboard 14, a processing unit 16 with associated application software, a microphone 17, and an input pad 18 for handwriting input. The display 12, keyboard 14, microphone 17 and input pad 18 are all connected to the processing unit 16. A user can speak into the microphone 17 to input a character into the processing unit 16 by way of voice recognition software. Similarly, the user may write upon the input pad 18 to input a character into the processing unit 16 by way of character recognition software. Both the microphone 17 and the input pad 18 are designed to be operated at the same time. The application software running on the processing unit 16 is thus able to generate at least one character that is most closely matched according to verbal inputs by the microphone 17, or handwriting inputs from the input pad 18. These matching characters are then presented on the display 12 to the user to allow the user to select a desired character.

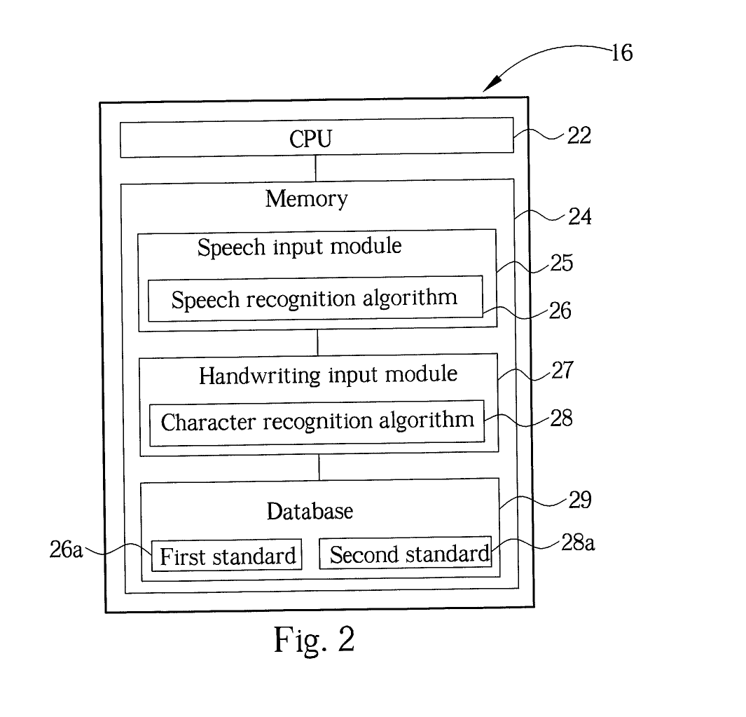

Please refer to FIG. 2 in conjunction with FIG. 1. FIG. 2 is a block diagram of a first embodiment for the processing unit 16 shown in FIG. 1. Within the processing unit 16 there exists at least a central processing unit (CPU) 22 and a memory 24 for storing application software and digital information. The memory 24 includes a speech input module 25 with a speech recognition algorithm 26, a handwriting input module 27 with a character recognition algorithm 28 and a database 29. The speech input module 25 obtains verbal data from the microphone 17, and uses the speech recognition algorithm 26 to generate a character, or characters, according to this verbal data. The handwriting input module 27 obtains handwriting data from the input pad 18, and the character recognition algorithm 28 uses the handwriting data to generate a corresponding character or characters. Thus, apart from the microphone 17 and the input pad 18, most of the input method shown in FIG. 2 is performed in the processing unit 16 as software. Both the speech recognition algorithm 26 and the character recognition algorithm 28 utilize the database 29 to perform their respective tasks.

The input method of the present invention must adjust itself to the particular characteristics of the user's pronunciation and handwriting. This function is performed by both the speech recognition algorithm 26 and the character recognition algorithm 28. The speech recognition algorithm 28 is initially configured to recognize characters pronounced according to a first standard 26a, the first standard 26a being a broad average of the most prevailing verbal characteristics of a specific kind of language. Characteristics of the first standard 26a are stored in the database 29. During a training process, characteristics of the first standard 26a are slowly modified and added to, thus eventually conforming to the user's verbal style. When the speech recognition algorithm 26 is unable to recognize a pronounced word, the user may use the keyboard 14 to enter the corresponding character 14. The unrecognized word is then associated with the character in the database 29, becoming part of the adapted first standard 26a. Similarly, the character recognition algorithm 28 is initially configured to recognize characters written according to a second standard 28a. In a process analogous to that for the speech recognition algorithm 26, the user can train the character recognition algorithm 28 to recognize the user's unique form of handwriting. As the character recognition algorithm 28 is trained, the second standard 28a is adjusted according to the characteristics of the user's handwriting. Unrecognized handwritten characters may be manually entered by way of the keyboard 14 to facilitate the training process, the characteristics of such handwritten characters then being added to the second standard 28a.

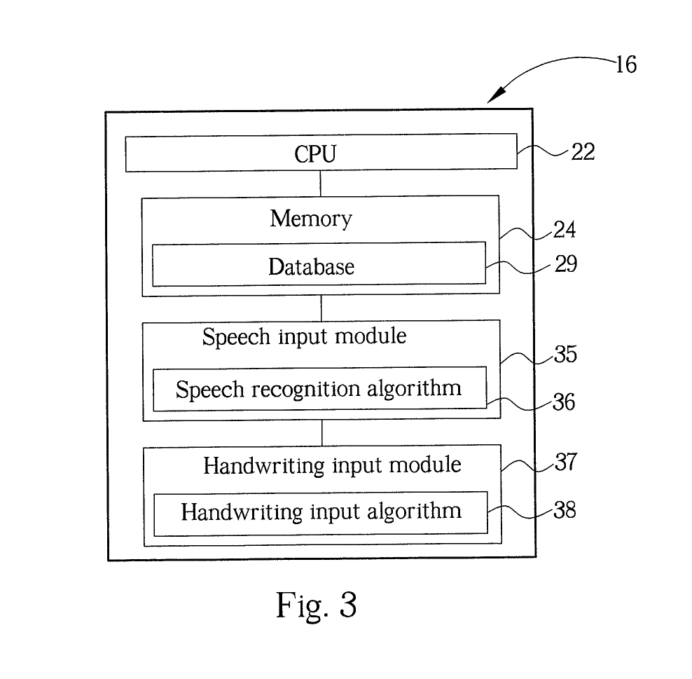

Please refer to FIG. 3 in conjunction with FIG. 1. FIG. 3 is a block diagram of a second embodiment for the processing unit 16 shown in FIG. 1. In contrast to the first embodiment shown in FIG. 2, much of the recognition in the second embodiment is performed in hardware. Within the processing unit 16 there exists at least a central processing unit (CPU) 22 and a memory 24 for storing application software and digital information. There is also a speech input module 35 with a speech recognition algorithm 36, and a handwriting input module 37 with a character recognition algorithm 38. The memory 24 includes the database 29 for storing information for the speech input module 35 and the handwriting input module 37. The CPU 22, the memory 24, the speech input module 35, and the handwriting input module 37 are connected to each other electrically. As in the previous embodiment, the speech input module 35 and handwriting input module 37 utilize the database 29 to perform their respective functions, and are capable of adapting to the particular verbal and writing characteristics of the user.

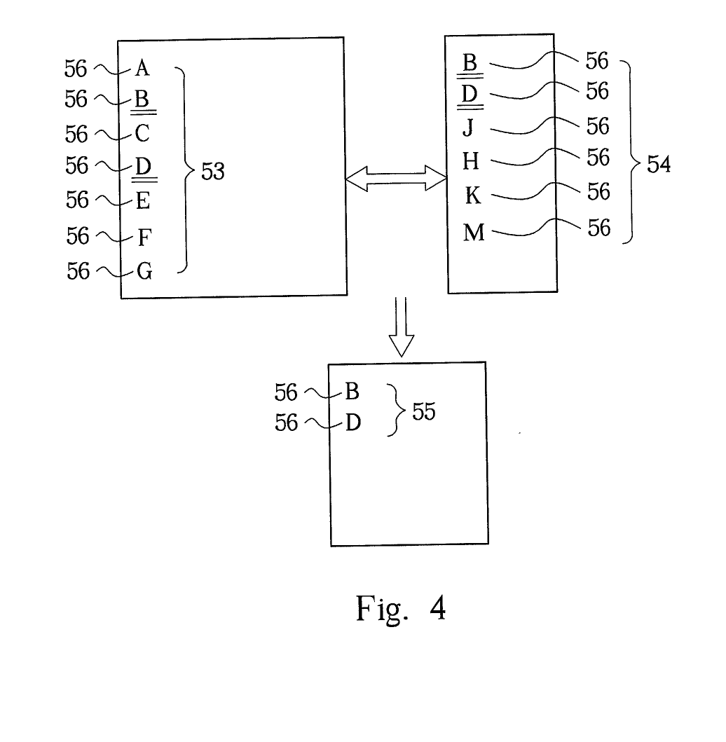

Please refer to FIG. 4, with reference to the previous figures. FIG. 4 is a schematic diagram for a first list 53, a second list 54, and a third list 55 generated according to the present invention method. After building up and configuring the contents of the database 29, the computer system 10 adopting the input method of the present invention is ready for use. The user can input characters by way of the microphone 17 and the input pad 18. The speech input module 25, 35 generates the first list 53 with at least one character 56 that potentially matches the verbal input of the user according to the speech recognition algorithm 26, 36. Simultaneously, the handwriting input module 27, 37 also generates the second list 54 with at least one character 56 that possibly matches the handwritten input according to the character recognition algorithm 28, 38. The computer system 10 then generates the third list 55 utilizing the first list 53 and second list 54. The third list 55 is the intersection of common characters from the first list 53 and the second list 54. For example, the list 53 generated from the speech recognition algorithm 26, 36 may include characters 56 such as A, B, C, D, E, F, and G. The second list 54 generated from the character recognition algorithm 28, 38 may include characters 56 such as B, D, J, H, K, and M. The computer system 10 thus generates the third list 55 with characters 56 of B and D. The third list 55 is then presented to the user, so that the user may select B or D. In this manner, the selection offered to the user is greatly reduced, simplifying the input process for the user. In the event that only a single character 56 is in the third list 55, this single character 56 may be automatically selected for the user, rather than presented and waiting for selection. With such an automatic selection process, the entire input process may be speeded up. In the event that the third list 55 is empty, i.e., that no characters 56 common to the first list 53 and the second list 54 were found, the user may have to manually enter in the desired character by way of the keyboard 14. The characteristics, verbal and written, of this missed character are then entered into the database 29. In this manner, the training process for the speech recognition algorithm 26, 36 and character recognition algorithm 28, 38 is continual. Though in this embodiment, the contents of the first list 53, the second list 54, and the third list 55 are single characters 56, there is no doubt that the contents of the first list 53, the second list 54, and the third list 55 could also be at least one string of characters 56. That is, rather than working at simply a character level, the input method could also work at a sentence level.

In contrast to the prior art, the input method according to the present invention integrates a speech input method with a handwriting input method. The two input methods are used at the same time to generate a character list with a single character, or a string of characters, which is an intersection of characters common to the outputs from the speech input method and the handwriting input method. As a result, the input method according to the present invention saves a lot of time spent on selecting characters from the speech input method and the handwriting input method, as well as easing the burden of typing characters for people who are not well training in typing. The present invention also saves time spent identifying verbal inputs because of the cooperation of the handwriting input method. Because the speech input method and the handwriting input method each has its own weakness, combining and integrating both of them is much more beneficial than using each of them independently.

Those skilled in the art will readily observe that numerous modifications and alterations of the device may be made while retaining the teachings of the invention. Accordingly, the above disclosure should be construed as limited only by metes and bounds of the appended claims.

What is claimed is:

1. An input method combining verbal and handwritten inputs, the input method comprising:
utilizing a speech recognition algorithm to generate a first list according to verbal input;
utilizing a character recognition algorithm to generate a second list according to handwritten input;
generating a third list that is an intersection of characters common to the first list and the second list; and
presenting at least a character from the third list to a user.

2. The input method of claim 1 further comprising providing at least a database from which characters are selected by the speech recognition algorithm and the character recognition algorithm to fill the first list and the second list, respectively.

3. The input method of claim 2 further comprising adding a first character to the database, the first character generated by the user using an auxiliary input method.

4. The input method of claim 3 wherein the speech recognition algorithm utilizes a first standard for speech recognition, and adapts the first standard to verbal characteristics of the user.

5. The input method of claim 4 wherein the verbal characteristics of the user corresponding to the first character are added to the database.

6. The input method of claim 3 wherein the character recognition algorithm utilizes a second standard for character recognition, and adapts the second standard to handwriting characteristics of the user.

7. The input method of claim 6 wherein the handwriting characteristics of the user corresponding to the first character are added to the database.

8. The input method of claim 3 wherein the auxiliary input method involves the use of a keyboard to generate the first character.
